(19) United States
(12) Patent Application Publication
(10) Pub. No.: US 2008/0006179 A1
(43) Pub. Date: Jan. 10, 2008

(54) CURABLE ORGANOPOLYSILOXANE COMPOSITIONS

(75) Inventors: Johann Mueller, Konzell (DE); Klaus Schnitzer, Julbach (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/772,285

(22) Filed: Jul. 2, 2007

(30) Foreign Application Priority Data
Jul. 5, 2006 (DE) 10 2006 031 107.8

(51) Int. Cl. C04B 41/50; B05D 3/02

(52) U.S. Cl. 106/287.14; 427/387

(57) ABSTRACT

The present invention relates to silicone compositions crosslinkable by addition of Si-bound hydrogen onto aliphatic multiple bonds, and comprising organic acids having a boiling point above 100° C. at a pressure of 1013 hPa, processes for their production and their use, in particular for coating textile fabrics.

### BACKGROUND OF THE INVENTION

1. Field of the Invention

The present invention relates to silicone compositions crosslinkable by addition of Si-bound hydrogen onto aliphatic multiple bonds and comprising organic acids, processes for their production and their use, in particular for coating textile fabrics.

2. Background Art

Addition-crosslinking silicone compositions cure by reaction of aliphatically unsaturated groups with Si-bound hydrogen (hydrosilylation) in the presence of a catalyst, typically a platinum compound. It is well known to use addition-crosslinking compositions for coating numerous substrates, such as plastics, metals, mineral materials and organic fibers. The individual constituents of the crosslinkable compositions must be coordinated such that the requirements for industrial use can be met. Reference in this connection may be made to EP 915 937 B1, for example.

### SUMMARY OF THE INVENTION

The present invention provides a silicone composition crosslinkable by addition of Si-bound hydrogen onto aliphatic multiple bonds and comprising an organic acid having a boiling point above 100° C. at a pressure of 1013 hPa.

### DETAILED DESCRIPTION OF THE PREFERRED EMBODIMENT(S)

The crosslinkable composition preferably comprises:
(A) an organosilicon compound having an SiC-bound radical with aliphatic multiple bonds,
(B) an organosilicon compound having an Si-bound hydrogen atom, or in addition to or in lieu of (1) and (2)
(C) an organosilicon compound having an SiC-bound radical with aliphatic multiple bonding and an Si-bound hydrogen atom,
(D) a catalyst which promotes the addition of Si-bound hydrogen onto aliphatic multiple bonds, and
(E) an organic acid having a boiling point above 100° C. at a pressure of 1013 hPa.

As used herein, the term “organopolysiloxanes” includes polymeric, oligomeric and dimeric siloxanes wherein some of the silicon atoms may be bonded to each other through groups other than oxygen, as for example via - or —C—.

The compositions of the present invention may comprise one-component organopolysiloxane compositions and two-component organopolysiloxane compositions. In the latter case, the two components of the compositions of the present invention may contain all the constituents in any desired combination, generally with the proviso that one component does not simultaneously contain siloxanes having aliphatic multiple bonding, siloxanes having Si-bound hydrogen and a catalyst. The compositions of the present invention are preferably two-component compositions.

The compounds (A) and (B) or (C) employed in the compositions of the present invention are chosen, as is known, such that crosslinking is possible. Preferably, for example, compound (A) has at least two aliphatically unsaturated radicals and siloxane (B) at least three Si-bound hydrogen atoms, or compound (A) has at least three aliphatically unsaturated radicals and siloxane (B) at least two Si-bound hydrogen atoms, or alternatively siloxane (C) is used partially or wholly in place of compounds (A) and (B) such that the aliphatically unsaturated radicals and Si-bound hydrogen atoms are provided in the abovementioned ratios.

A useful organosilicon compound (A) is any organosilicon compound having aliphatic multiple bonding and as previously used in addition-crosslinkable compositions.

The organosilicon compounds (A) preferably comprise siloxanes comprising units of the formula
RₐR¹_{b}SiO_{(4-a-b)/2} (I),
where
R in each occurrence may be the same or different and is a radical free of an aliphatic carbon-carbon multiple bond,
R¹ in each occurrence may be the same or different and is a univalent, optionally substituted, SiC-bound hydrocarbyl radical with aliphatic carbon-carbon multiple bonding,
a is 0, 1, 2 or 3, and
b is 0, 1 or 2,
   with the proviso that the sum total of a+b is not more than 3 and there are at least 2 R¹ radicals per molecule.

The R radical may comprise uni- or polyvalent radicals, in which case the polyvalent radicals, such as bivalent, trivalent and tetravalent radicals, then bond a plurality of, such as for example two, three or four, siloxy units of the formula (I) together. Univalent radicals R include —F, —Cl, —Br, —OR⁶, —CN, —SCN, —NCO and SiC-bound, optionally substituted hydrocarbyl radicals, which may be interrupted by oxygen atoms or the group —C(O)—. R also includes bivalent radicals Si-bonded on both sides as per formula (I).

When R comprises SiC-bound, substituted hydrocarbyl radicals, preferred substituents are halogen atoms, phosphorus-containing radicals, cyano radicals, —OR⁶, —NR⁶—, —NR⁶₂, —NR⁶—C(O)—NR⁶₂, —C(O)—NR⁶₂, —C(O)—R⁶, —C(O)OR⁶, —SO₂—Ph and —C₆F₅, where R⁶ can be the same or different and is a hydrogen atom or a univalent hydrocarbyl radical of 1 to 20 carbon atoms and Ph is phenyl.

Examples of R radicals are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radicals, heptyl radicals such as the n-heptyl radicals, octyl radicals such as the n-octyl and isooctyl radicals such as the 2,2,4-trimethylpentyl radical, nonyl radicals such as the n-nonyl radicals, decyl radicals, such as the n-decyl radicals, dodecyl radicals such as the n-dodecyl radicals, and octadecyl radicaols such as the n-octadecyl radicals, cycloalkyl radicals, such as the cyclopentyl, cyclohexyl, cycloheptyl and methylcyclohexyl radicals, aryl radicals such as the phenyl, naphthyl, anthryl and phenanthryl radicals, alkaryl radicals, such as the o-, m-, p-tolyl, xylyl and ethylphenyl radicals, and aralkyl radicals, such as the benzyl, a-phenylethyl and P-phenylethyl radicals.

Examples of substituted R radicals are haloalkyl radicals, such as the 3,3,3-trifluoro-n-propyl, 2,2,2,2′,2′,2′-hexafluoroisopropyl and heptafluoroisopropyl radicals, and also haloaryl radicals such as the o-, m- and p-chlorophenyl radicals.

The R radical preferably comprises a univalent, SiC-bound, optionally substituted hydrocarbyl radical of 1 to 18 carbon atoms which is free of aliphatic carbon-carbon multiple bonding, more preferably a univalent, SiC-bound hydrocarbyl radical of 1 to 6 carbon atoms which is free of aliphatic carbon-carbon multiple bonding, in particular the methyl or phenyl radicals.

The R¹ radical may comprise any desired groups accessible to an addition reaction (hydrosilylation) with an SiH-functional compound. When R¹ comprises SiC-bound, substituted hydrocarbyl radicals, preferred substituents are halogen atoms, cyano radicals and —OR⁶, where R⁶ is as defined above.

R¹ preferably comprises alkenyl and alkynyl groups of 2 to 16 carbon atoms, such as vinyl, allyl, 1-propenyl, methallyl, 5-hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl and styryl, of which the use of vinyl, allyl and 5-hexenyl is particularly preferred.

The molecular weight of substituent (A) can vary within wide limits, for example between 10 and 10⁶ g/mol, although a molecular weight of 50 to 500,000 g/mol is preferred. Thus, constituent (A) may comprise for example a relatively low molecular weight alkenyl-functional oligosiloxane, such as 1,2-divinyltetramethyldisiloxane, but also a polydimethylsiloxane high polymer having chain-disposed and/or terminal Si-bound vinyl groups. Nor is the structure of the molecules forming constituent (A) fixed; in particular, the structure of a comparatively high molecular weight, i.e., oligomeric or polymeric, siloxane may be linear, cyclic or branched.

Preference for use as component (A) is given to the use of essentially linear polydiorganosiloxanes having a viscosity of 20 to 1,000,000 mm²/s, with particular preference being given to vinyl-terminated, essentially linear polydiorganosiloxanes having a viscosity of 50 to 500,000 mm²/s, all at 25° C.

The organosilicon compound (B) can be any hydrogen-functional organosilicon compound useful in addition-crosslinkable compositions.

Preferred organopolysiloxanes (B), which have Si-bound hydrogen atoms, are organopolisiloxanes comprising units of the formula
R²_{c}H_{d}SiO_{(4-c-d)/2} (II)
where
R² in each occurrence can be the same or different and has one of the meanings indicated above for R,
c is 0, 1, 2 or 3, and
d is 0, 1 or 2,
   with the proviso that the sum total of c+d is not more than 3 and there are at least two and preferably at least three Si-bound hydrogen atoms per molecule.

Preferably, the organosilicon compound (B) used according to the present invention contains Si-bound hydrogen in the range from 0.04 to 1.7 weight percent, based on the total weight of the organosilicon compound (B).

The molecular weight of constituent (B) can likewise vary within wide limits, for example between 10 and 10⁶ g/mol. For instance, constituent (B) may comprise for example a relatively low molecular weight SiH-functional oligosiloxane, such as tetramethyldisiloxane, or else a linear polysiloxane high polymer having chain-disposed or terminal SiH groups, or an SiH-containing silicone resin. Nor is the structure of the molecules forming the constituent (B) fixed; more particularly, the structure of a comparatively high molecular weight, i.e., oligomeric or polymeric, SiH-containing siloxane can be linear, cyclic or branched. Linear and cyclic polysiloxanes are preferably composed of units of the formula R²₃SiO_{1/2}, HR²₂SiO_{1/2}, HR²SiO_{2/2} and R²₂SiO_{2/2}, where R² is as defined above.

Particular preference for use as component (B) is given to low molecular weight SiH-functional compounds, such as tetrakis(dimethylsiloxy)silane and tetramethylcyclotetrasiloxane, and also comparatively high molecular weight, SiH-containing siloxanes, such as poly(hydromethyl)siloxane and poly(dimethyl/hydromethyl)siloxane having a viscosity at 25° C. of 10 to 10,000 mm²/S, or analogous SiH-containing compounds wherein some of the methyl groups are replaced by 3,3,3-trifluoropropyl or phenyl groups.

Constituent (B) is preferably present in the present invention's crosslinkable compositions in such an amount that the molar ratio of SiH groups to aliphatically unsaturated groups is in the range from 0.1 to 20 and more preferably between 1.0 and 5.0.

The components (A) and (B) used according to the present invention are commercially available products or obtainable by common chemical processes.

In lieu of components (A) and (B), the compositions of the present invention may include organopolysiloxanes (C) having not only aliphatic multiple bonds but also Si-bound hydrogen atoms, but this is not preferred. Component (C) may be used in conjunction with components (A) and (B) as well.

When siloxanes (C) are used, they are preferably such as comprise units of the formula
R³_{f}SiO_{(4-f)/2}, R³_{g}R¹SiO_{(3-g)/2} and R³ₕHSiO_{(3-g)/2},
where R³ in each occurrence may be the same or different and has one of the meanings indicated for R and R¹ is as defined above,
f is 0, 1, 2 or 3,
g is 0, 1 or 2, and
h is 0, 1 or 2,
   with the proviso that at least 2 R¹ radicals and at least 2 Si-bound hydrogen atoms are present per molecule.

Examples of organopolysiloxanes (C) are linear organopolysiloxanes consisting essentially of R³₂R¹SiO_{1/2}—, R³₂SiO— and R³HSiO— units where R³ and R¹ are each as defined above. The organopolysiloxanes (C) preferably have an average viscosity of 20 to 1,000,000 mm²/s and more preferably 50 to 500,000 mm²/s, all at 25° C. Organopolysiloxanes (C) are obtainable by common chemical methods.

Component (D) used according to the present invention can be any catalyst hitherto used in compositions crosslinkable by addition of Si-bound hydrogen onto aliphatic multiple bonding. Preferably, components (D) comprise hydrosilylation catalysts from group 8, 9 or 10 of the Periodic Table. Thus, metals and their compounds such as platinum, rhodium, palladium, ruthenium and iridium, preferably platinum, can be used. The metals may if appropriate be fixed on finely divided support materials, such as activated carbon, metal oxides, alumina or silica.

Preferred hydrosilylation catalysts (D) are platinum and platinum compounds, more preferably such platinum compounds which are soluble in polyorganosiloxanes. Soluble platinum compounds include for example the platinum-olefin complexes of the formulae (PtCl₂.olefin)₂ and ^{H}(PtCl₃.olefin), which preferably utilize alkenes of 2 to 8 carbon atoms, such as ethylene, propylene, isomers of butene and of octene, or cycloalkanes of 5 to 7 carbon atoms, such as cyclopentene, cyclohexene and cycloheptene. Useful soluble platinum catalysts further include the platinum-cyclopropane complex of the formula (PtCl₂C₃H₆)₂, the reaction products of hexachloroplatinic acid with alcohols, ethers and aldehydes or mixtures thereof, or the reaction product of hexachloroplatinic acid with methylvinylcyclotetrasiloxane in the presence of sodium carbonate in ethanolic solution. It is similarly possible to use platinum catalysts with phosphorus, sulfur and amine ligands, an example being (Ph₃P)₂PtCl₂. Particular preference for use as component (D) is given to complexes of platinum with vinylsiloxanes, such as symdivinyltetramethyldisiloxane.

The amount of the hydrosilylation catalyst (D) used according to the present invention depends on the desired rate of crosslinking and on the particular use and also economic aspects. The compositions of the present invention preferably include platinum catalysts (D) in such amounts as to give a platinum content of 0.01 to 1000 weight ppm (parts by weight per million parts by weight), more preferably 0.05 to 500 weight ppm and particularly 0.1 to 100 weight ppm, all based on the total weight of the composition of the present invention.

The acids (E) used according to the present invention preferably are acids that do not inhibit the hydrosilylation catalyst (D) and provide reduced odor in the silicone rubber formulation of the present invention. Preferably, the organic acids (E) are miscible or dispersible with the organosilicon compounds described under (A), or incorporable into component (A) in the form of a solution in volatile organic solvents, examples being ethanol, butanol, isopropanol or acetone.

The organic acids contain preferably at least 2 and more preferably 2 to 20 carbon atoms. The organic acids (E) may contain one or more carboxyl groups. More particularly, the organic acids of 2 to 5 carbon atoms have at least two carboxyl groups. The organic acids (E) preferably have a boiling point above 150° C. and especially above 180° C., both at a pressure of 1013 hPa. The pKa value of the organic acids (E) is preferably in the range from 1.6 to 5.0.

Examples of organic acids (E) are undecenoic acid, ethylhexanoic acid, oleic acid, stearic acid, isostearic acid, dodecenoic acid, malic acid and citric acid, of which undecenoic acid, oleic acid, malic acid and citric acid are preferred and malic acid and citric acid are particularly preferred.

Organic acids (E) are used in an amount of preferably 0.01 to 10 parts by weight, more preferably 0.05 to 7 parts by weight and particularly 0.1 to 5 parts by weight, all based on 100 parts by weight of crosslinkable composition of the present invention.

In addition to the components (A) to (E), the curable compositions of the present invention may include any component hitherto used for producing addition-crosslinkable compositions, examples being inhibitors (F), fillers (G), adhesion promoters (H) and also further materials (I) selected from solvents, pigments, dyes, plasticizers, organic polymers, heat stabilizers and fragrances.

The optional inhibitors (F) are incorporated, when employed, to specifically adjust the pot life, light-off temperature and crosslinking rate of the compositions, examples being acetylenic alcohols such as 1-ethynyl-1-cyclohexanol, 2-methyl-3-butyn-2-ol, 3,5-dimethyl-1-hexyn-3-ol and 3-methyl-1-dodecyn-3-ol, trialkyl cyanurates, alkyl maleates such as diallyl maleates, dimethyl maleate and diethyl maleate, alkyl fumarates such as diallyl fumarate and diethyl fumarate, organic hydroperoxides such as cumene hydroperoxide, tert-butyl hydroperoxide and pinane hydroperoxide, organic peroxides, organic sulfoxides, organic amines, diamines and amides, phosphines and phosphites, nitriles, triazoles, diaziridines, and oximes.

The inhibitors (F) preferably comprise ethynylcyclohexanol, 2-methyl-3-butyn-2-ol and alkyl maleates, of which ethynylcyclohexanol and 2-methyl-3-butyn-2-ol are particularly preferred. The compositions of the present invention preferably include component (F) in amounts of 0.01 to 3 parts by weight, more preferably 0.02 to 1 part by weight and most preferably 0.03 to 0.5 parts by weight, all based on 100 parts by weight of component (A).

The optional fillers (G) can be any fillers in crosslinkable compositions. Examples of fillers are reinforcing fillers, i.e., fillers having a BET surface area of at least 30 m²/g, for example carbon blacks, fumed silica, precipitated silica and silicon-aluminum mixed oxides, optionally be in a hydrophobicized state, and also nonreinforcing fillers, i.e., fillers having a BET surface area of less than 30 m²/g, for example powders of quartz, crystobalite, diatomaceous earth, calcium silicate, zirconium silicate, montmorillonites, such as bentonites, zeolites, including molecular sieves, such as sodium aluminosilicate, metal oxides such as aluminum oxide, zinc oxide or mixed oxides, metal hydroxides such as aluminum hydroxide, barium sulfate, calcium carbonate, gypsum, silicon nitride, silicon carbide, boron nitride, powders of glass, of carbon and of plastic, and microballoons of glass and of plastic.

The filler (G) preferably comprises fumed silicas or precipitated silicas, particular preference being given to fumed silica having a BET surface area in the range from 30 to 300 m²/g. When the compositions of the present invention include fillers (G), which is preferred, the amounts involved preferably range from 1 to 50 parts by weight and more preferably from 2 to 30 parts by weight, all based on 100 parts by weight of crosslinkable composition.

Adhesion promoters (H) which are optionally included in the compositions can be any adhesion promoter useful in compositions crosslinkable by addition of Si-bound hydrogen onto aliphatic multiple bonding. The adhesion promoters are preferably silane adhesion promoters, examples being vinyltrialkoxysilanes, methacryloyloxypropyltrialkoxysilanes, epoxypropyltrialkoxysilanes, silanes having acetoxy groups, and mixtures thereof.

It is particularly preferred for the adhesion promoters (H) to be epoxypropyltriethoxysilane, epoxypropyltrimethoxysilane and vinyltriacetoxysilane. When the compositions of the present invention include adhesion promoters (H), which is preferred, the amounts involved preferably range from 0.01 to 20 parts by weight, more preferably from 0.05 to 10 parts by weight and particularly from 0.1 to 5 parts by weight, all based on 100 parts by weight of component (A).

Further materials (I) used in the present invention's compositions where appropriate may be any solvent, pigment, dye, plasticizer, organic polymer, heat stabilizer or fragrance for those purposes, which are useful in compositions crosslinkable by addition of Si-bound hydrogen onto aliphatic multiple bonding and different than components (A) to (H).

Examples of solvents are aliphatics having 7 to 20 carbon atoms, toluene, xylene, acid esters, for example ethyl acetate, or ketones, such as methyl ethyl ketone.

Examples of plasticizers are nonfunctional trimethyl-terminated polydimethylsiloxanes, aliphatics having 15 to 30 carbon atoms and nonfunctional methylphenylpolysiloxanes.

Examples of organic polymers are polyacrylates, polyurethanes, polyacrylonitrile, polycarbonates, and polyesters.

Examples of heat stabilizers are cerium oxides, organic cerium compounds such as cerium octoate, iron oxides and titanium oxides.

When the present invention's compositions include further materials (I), these further materials (I) preferably comprise solvents, such as aliphatic benzines, toluene, xylene or acid esters such as ethyl acetate.

When the compositions include further materials (I), which is not preferred, the amounts involved preferably range from 0.01 to 60 parts by weight, more preferably from 0.05 to 50 parts by weight and particularly from 0.1 to 30 parts by weight, all based on 100 parts by weight of component (A).

The compositions of the present invention are preferably liquid or pourable at room temperature and ambient pressure. Their viscosity is preferably in the range from 20 to 1,000,000 mm²/s and more preferably in the range from 50 to 500,000 mm²/s, all at 25° C.

The compositions of the present invention preferably consist of
(A) an organosilicon compound comprising a unit of the formula (I),
(B) an organopolysiloxane having an Si-bound hydrogen atom,
(D) a catalyst that promotes the addition of Si-bound hydrogen onto aliphatic multiple bonding,
(E) an organic acid having a boiling point above 100° C. at a pressure of 1013 hPa,
(F) optionally, an inhibitor,
(G) optionally, a filler,
(H) optionally, an adhesion promoter and
(I) optionally, further materials other than said components (A) to (H) and selected from solvents, pigments, dyes, plasticizers, organic polymers, heat stabilizers and fragrances.

More particularly, the compositions of the present invention consist of
(A) vinyl-terminated diorganopolysiloxanes,
(B) organopolysiloxanes having Si-bound hydrogen atoms,
(D) catalysts promoting the addition of Si-bound hydrogen onto aliphatic multiple bonding,
(E) an organic acid having a boiling point above 100° C. at a pressure of 1013 hPa,
(F) inhibitors,
(G) fillers,
(H) silane adhesion promoters, and
(I) optionally, further materials other than said components (A) to (H) and selected from solvents, pigments, dyes, plasticizers, organic polymers, heat stabilizers, nonreinforcing fillers and fragrances.

The components (A) to (I) may each comprise a single kind of such a component as well as a mixture of at least two different kinds of such a component. The organopolysiloxane compositions of the invention can be produced according to known processes, for example by uniformly mixing the individual components together in any desired order.

Depending on the consistency and viscosity of the components used, the mixing operation can be effected using simple stirred equipment, examples being vane stirrers, planetary mixers, turbostirrers or dissolvers, in roll mills, kneaders, Z-mixers or ball mills. The stirred vessel can be open or closed. The mixing step is preferably carried out at room temperature, but temperatures in the range from −40° C. to 150° C. are also possible. The acid (E) used according to the present invention may be mixed into the silicone rubber formulation already containing all the other components, or into one or more of the corresponding premixers. Similarly, the organic acid may be incorporated during the production of the silicone rubber mixture. If desired, the acid (E) can also be used in admixture with solvents.

The mixing step to produce the compositions of the present invention is preferably carried out at the pressure of the ambient atmosphere, i.e., about 900 to 1100 hPa, although, if desired, an elevated or reduced pressure and also protective gas can be employed. When the organic acid (E) used according to the present invention is added in admixture with solvent, the solvent can be removed again if desired by applying a vacuum and/or raising the mixing temperature.

The mixing operation to produce the compositions of the present invention can be carried out batchwise or else continuously in equipment suitable for the purpose. Examples of such equipment are Buss kneaders and also static or dynamic in-line mixers.

The compositions of the present invention, which are crosslinkable by addition of Si-bound hydrogen onto aliphatic multiple bonding, can be allowed to crosslink under the same conditions as the prior art compositions crosslinkable by hydrosilylation reaction. Preferably the temperature ranges from 100 to 220° C. and more preferably from 130 to 190° C., and the pressure from 900 to 1100 hPa. However, higher or lower temperatures and pressures can also be employed.

The present invention further provides shaped articles obtained by crosslinking the compositions of the present invention. The shaped articles of the present invention can be obtained in any desired manner known per se. Examples thereof are calendering, compression molding, injection molding, extrusion, casting. The compositions of the present invention can also be used for coating surfaces.

The compositions of the invention and the crosslinked products obtained therefrom can be used for any purpose for which elastomers or organopolysiloxane compositions crosslinkable to elastomers are useful. More particularly, the compositions of the present invention are useful for coating textile fabrics, examples being wovens, nonwovens, drawn-loop knits, laid scrims, formed-loop knits, felts or warp knits. The textile fabrics may be fabricated from natural fibers, such as cotton, wool, silk, etc. or else from manufactured fibers such as polyester, polyamide, aramid, etc. The textiles may also be fabricated from mineral fibers, such as glass or silicates or metal fibers. The compositions of the present invention are also useful for coating foils or surfaces composed of mineral materials, plastics, natural materials or metals.

The present invention further provides a process for coating a textile fabric, which comprises the composition of the present invention being applied to the textile fabric and allowed to crosslink.

The coating according to the present invention can be applied in a conventional manner, for example blade coating, dip coating, extrusion processes, squirting or spraying processes. Similarly, all varieties of roller coatings, such as gravure rolls, padding or application via multiroll systems and also screen printing are possible.

The coating according to the present invention is preferably carried out at temperatures in the range from 10 to 50° C. and at a pressure of the ambient atmosphere, i.e., about 900 to 1100 hPa.

The compositions of the present invention are also useful for laminating and for processing in the transfer process.

The textile fabrics coated with the compositions of the present invention can be used wherever coated wovens are already being used. The coated wovens of the present invention may preferably be used where particularly odor-neutral coatings having low emission values and good adhesion to the substrate are required. Examples thereof are bellow expansion joints for public means of transport or public buildings, curtains, light-protective textiles, awnings or safety restraint systems in automobiles.

The crosslinkable compositions of the present invention have the advantage of being obtainable in a simple process from readily available starting materials and hence of being obtainable in an economical manner. The crosslinkable compositions of the present invention have the further advantages of good storage stability and ease of processing in customary equipment.

The shaped articles of the present invention have the advantage of reduced emission values, and the further advantage of reduced intrinsic odor. The inventive process allows for increased processing speeds.

In the examples described hereinbelow, all parts and percentages are by weight, unless otherwise stated. Again, unless otherwise stated, the examples which follow are carried out at a pressure of the ambient atmosphere, i.e., about 1000 hPa say, and at room temperature, i.e., at about 20° C., or at a temperature which autogenously results on combining the reactants at room temperature without additional heating or cooling. All viscosities relate to a temperature of 25° C.

### EXAMPLE 1

### Production of an Addition-Crosslinking Base Composition (Hereinafter Referred to as “Base Composition”)

120 g of an α,ω-vinyldimethylsiloxy-terminated polydimethylsiloxane having a viscosity of 20,000 mPa·s are mixed with 156 g of an α,ω-vinyldimethylsiloxy-terminated polydimethylsiloxane having a viscosity of 1000 mPa·s, and 55 g of a finely divided silica having a BET surface area of 300 g/m². Into mixture is then incorporated 0.06 g of a platinum-divinyltetramethylsiloxane complex dissolved in dimethylpolysiloxane to provide a platinum content of 18 ppm, 10 g of methylhydropolysiloxane having trimethyl end groups and a viscosity of 45 mPa·s, and 1.5 g of ethynylcyclohexanol.

To 100 g of the base composition thus produced are added and mixed 3 g of a 33% solution of citric acid in ethanol.

### EXAMPLE 2

To 100 g of the base composition produced in Example 1 are added 4 g of a 20% solution of citric acid in butanol.

### EXAMPLE 3

To 100 g of the base composition of Example 1 are added 2 g of undecenoic acid.

### EXAMPLE 4

To 100 g of the base composition of Example 1 are added 3 g of oleic acid.

### EXAMPLE 5

### Determination of Vulcanization Time Needed at a Vulcanization Temperature of 180° C.

The mixtures as per Examples 1 to 4 and also the base composition as such for comparison (Comparative Example 1 (C1)) are each blade coated onto a woven nylon-6,6 fabric and vulcanized at 180° C. The fabric thus coated is subjected to an extraction test and the residence time needed until extractables <10% is determined as described hereinbelow.

The extractables content of the crosslinked silicone rubber was determined as an indicator of the vulcanization status. To this end, a coated fabric is stored in methyl isobutyl ketone for 24 hours and the silicone content of the solvent is determined. The vulcanization time needed to reach 10% extractables was determined. The results are given in Table 1.

TABLE 1

| | |
|---|---|
| Coating of Comparative Example 1 | 46 seconds |
| Coating of Example 1 | 13 seconds |
| Coating of Example 2 | 15 seconds |
| Coating of Example 3 | 35 seconds |
| Coating of Example 4 | 33 seconds |

### EXAMPLE 6

### Determination of Odor Evolution After Coating

The mixtures as per Examples 1 to 4 and also the base composition for comparison (Comparative Example 1) are each blade coated onto a woven loom-state, unwashed nylon fabric and vulcanized at 180° C. for 60 seconds. The fabric thus coated exhibits distinctly reduced odor in the odor test described hereinbelow.

100 cm² of the coated fabric was in each case placed in a jar and stored sealed for 24 hours. The jars were then opened and the odor assessed. The results are to be found in Table 2.

TABLE 2

| | |
|---|---|
| Coating of Comparative | Strong, fishy odor |
| Example C1 | |
| Coating of Example 1 | No detectable odor |
| Coating of Example 2 | No detectable odor |
| Coating of Example 3 | Weak odor, distinctly less than for C1 |
| Coating of Example 4 | Weak odor, distinctly less than for C1 |

### EXAMPLE 7

### Determination of Adhesion of Coating to Substrate

The mixtures as per Examples 1 to 4 and also the base composition for comparison (Comparative Example 1) are each blade coated onto a washed woven nylon fabric and vulcanized at 180° C. for 30 seconds.

The coated fabric samples are each tested to ISO 5981 by coated fabric samples being moved diagonally in the opposite direction in a scrub tester under a metal pressure shoe and a 1 kg added weight. The results are to be found in Table 3. The fabric inventively coated exhibits distinctly better values in the ISO 5981 test.

TABLE 3

| | |
|---|---|
| Coating of Comparative Example 1 | 200 scrubs |
| Coating of Example 1 | 1800 scrubs |
| Coating of Example 2 | 1600 scrubs |
| Coating of Example 3 | 1200 scrubs |
| Coating of Example 4 | 900 scrubs |

### EXAMPLE 8

The mixtures as per Examples 1 to 4 and also the base composition for comparison (Comparative Example 1) are each blade coated onto a washed woven nylon fabric and vulcanized at various temperatures for 30 seconds. The fabric thus coated requires short vulcanization times.

Extractables were again determined as an indicator of the quality of crosslinking. Each of the coated fabric samples was subjected to the extraction test described in Example 5. Table 4 shows the temperature needed to achieve an extract value of below 10% within 30 seconds.

TABLE 4

| | |
|---|---|
| Coating of Comparative Example 1 | 185° C. |
| Coating of Example 1 | 152° C. |
| Coating of Example 2 | 154° C. |
| Coating of Example 3 | 173° C. |
| Coating of Example 4 | 168° C. |

### EXAMPLE 9

### Determination of Emissions (Volatiles) in the Coated Fabrics

The mixtures as per Examples 1 to 4 and also the base composition for comparison (Comparative Example 1) are each blade coated onto a woven nylon fabric and vulcanized at 180° C. for 1 minute.

The emissions from the fabric samples were determined to VDA 277/278 by determining the volatile fractions (as total carbon) with the aid of a GC-MS coupling by the thermodesorption process. The results are to be found in Table 5. The fabric inventively coated exhibits distinctly reduced emission values.

TABLE 5

| | |
|---|---|
| Coating of Comparative Example 1 | 124 ppm |
| Coating of Example 1 | 28 ppm |
| Coating of Example 2 | 19 ppm |
| Coating of Example 3 | 56 ppm |
| Coating of Example 4 | 48 ppm |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A silicone composition crosslinkable by addition of Si-bound hydrogen onto aliphatic multiple bonds comprising an organic acid having a boiling point above 100° C. at a pressure of 1013 hPa.

2. The crosslinkable composition of claim 1 comprising
(A) an organosilicon compound having at least one SiC-bound radical with aliphatic multiple bonding,
(B) an organosilicon compound having at least one Si-bound hydrogen atom, or
(C) in lieu of or in addition to (A) and (C), an organosilicon compound having at least one SiC-bound radical with aliphatic multiple bonding and an Si-bound hydrogen atom,
(D) a catalyst that promotes the addition of Si-bound hydrogen onto aliphatic multiple bonds, and
(E) an organic acid having a boiling point above 100° C. at a pressure of 1013 hPa.

3. The crosslinkable composition of claim 2, wherein said organosilicon compound (A) comprises a siloxane comprising at least one unit of the formula
RₐR¹_{b}SiO_{(4-a-b)/2} (I)
where
R in each occurrence may be the same or different and is a radical free of an aliphatic carbon-carbon multiple bond,
R¹ in each occurrence may be the same or different and is a univalent, optionally substituted, SiC-bound hydrocarbyl radical with aliphatic carbon-carbon multiple bonds,
a is 0, 1, 2 or 3, and
b is 0, 1 or 2,
with the proviso that the sum total of a+b is not more than 3 and there are at least 2 R¹ radicals per molecule.

4. The crosslinkable composition of claim 1, wherein said organic acid has 2 to 20 carbon atoms.

5. The crosslinkable composition of claim 3, comprising:
(A) an organosilicon compound comprising a unit of the formula (I),
(B) an organopolysiloxane having an Si-bound hydrogen atom,
(D) a catalyst that promotes the addition of Si-bound hydrogen onto aliphatic multiple bonding,
(E) an organic acid having a boiling point above 100° C. at a pressure of 1013 hPa,
(F) optionally, one or more inhibitors,
(G) optionally, one or more fillers,
(H) optionally, one or more adhesion promoters, and
(I) optionally, further materials other than said components (A) to (H) selected from group consisting of solvents, pigments, dyes, plasticizers, organic polymers, heat stabilizers and fragrances.

6. A shaped article obtained by crosslinking a composition of claim 1.

7. A shaped article obtained by crosslinking a composition of claim 2.

8. A shaped article obtained by crosslinking a composition of claim 3.

9. A process for coating a textile fabric, comprising coating a composition of claim 1 onto a textile fabric crosslinking the coating composition.

10. A process for coating a textile fabric, comprising coating a composition of claim 2 onto a textile fabric crosslinking the coating composition.

11. A process for coating a textile fabric, comprising coating a composition of claim 3 onto a textile fabric crosslinking the coating composition.

12. The composition of claim 1, wherein the organic acid is selected from the group consisting of organic acids (E) are undecenoic acid, ethylhexanoic acid, oleic acid, stearic acid, isostearic acid, dodecenoic acid, malic acid and citric acid, of which undecenoic acid, oleic acid, malic acid and citric acid are preferred and malic acid and citric acid, and mixtures thereof.
